(19) United States
(12) Patent Application Publication
(10) Pub. No.: US 2005/0074257 A1
(43) Pub. Date: Apr. 7, 2005

(54) Sealing member for sealing magnetic particles and developing apparatus using the sealing member

(75) Inventors: Yoshiyuki Batori, Mishima-shi (JP); Teruhiko Sasaki, Mishima-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/735,722

(22) Filed: Dec. 16, 2003

(30) Foreign Application Priority Data
Dec. 20, 2002 (JP) 371020/2002(PAT.)

(51) Int. Cl. G03G 15/08

(52) U.S. Cl. 399/104

(57) ABSTRACT

A developing apparatus includes a developing container for containing a developer; a developer carrying member to be rotated while carrying the developer thereon, the developer carrying member being provided in an opening portion of the developer container; and a sealing member which extends in a circumferential direction of the developer carrying member in the vicinity of an end of the developer carrying member and regulates movement of the developer toward the end of the developer carrying member by a magnetic force, the sealing member including an arcuate portion extended along a peripheral surface of the developer carrying member and a non-arcuate portion disposed at an end, in the circumferential direction, of the arcuate portion. An end surface of the arcuate portion of the sealing member on a side where the non-arcuate portion is not provided, is inclined such that a phantom plane including the end surface is closer to the arcuate portion than a center of arcuation of the arcuate portion.

### FIELD OF THE INVENTION AND RELATED ART

The present invention relates to a magnetic sealing member for preventing leakage of magnetic particles, for use in a developing apparatus, a process cartridge or an electrophotographic image forming apparatus, and a developing apparatus using the sealing member.

Here, an electrophotographic image forming apparatus means an apparatus which forms an image on recording medium with the use of an electrophotographic image forming method. Examples of an electrophotographic image forming apparatus include an electrophotographic copying machine, an electrophotographic printer (for example, laser printer, LED printer, etc.), a facsimile machine, a wordprocessor, a combination of two or more of the preceding apparatuses (multifunction printer, etc.), etc.

A process cartridge means: a cartridge in which a charging means, a developing means or a cleaning means, and an electrophotographic photoconductive member, are integrally disposed, and which is detachably mountable in the main assembly of an image forming apparatus; a cartridge in which a minimum of one among a charging means, a developing means, and cleaning means, and an electrophotographic photoconductive member, are integrally disposed, and which is detachably mountable in the main assembly of an image forming apparatus; or a cartridge in which a minimum of a developing apparatus and an electrophotographic photoconductive member are integrally disposed, and which is detachably mountable in the main assembly of an image forming apparatus.

A process cartridge system which has an electrophotographic photoconductive member, and a single or plurality of processing means which act on the electrophotographic photoconductive member, are integrally disposed in a cartridge detachably mountable in the main assembly of an image forming apparatus has long been employed by an electrophotographic image forming apparatus which uses an electrophotographic image firming process. According to a process cartridge system, an apparatus can be maintained by a user him/herself; it is unnecessary to hire a service person. Thus, the employment of a cartridge system drastically improves the apparatus in operational efficiency. Therefore, a cartridge system has been widely used in the field of an image forming apparatus.

In the developing apparatus used incorporated in such a process cartridge system, a sealing member for preventing leakage of developer toward the outside of a developing area is disposed at both ends of a rotating developer carrying member.

In the conventional image forming apparatus, an elastic member, such as felt or foamed rubber, has been utilized as the sealing member for preventing the developer leakage.

In addition to the elastic member, a magnetic material sealing member which has been multi-polarized to have N- and S-poles at its inner surface, has also been used.

The magnetic material sealing member has such a structure that it is disposed in a non-contact state with a predetermined spacing with a developer carrying member and prevents a developer from leaking from the developer carrying member under the action of a concentrated magnetic field created between the magnetic material sealing member and a magnet incorporated in the developer carrying member. The magnetic material sealing member is, different from the elastic member (felt or foamed rubber) described above, does not contact the developer carrying member, thus being advantageous in terms of prevention of an increase in torque and a deterioration of the sealing member.

Further, in recent years, a magnetic brush-type charging apparatus wherein electroconductive magnetic particles are held and carried to an image bearing member by a magnetic particle carrying member in which a magnet is disposed, a magnetic brush portion of the electroconductive magnetic particles magnetically forced to be held by the magnetic particle carrying member is caused to contact the image bearing member, and the magnetic particle carrying member is rotated to circulate and carry the magnetic brush portion to a contact portion with the image bearing member, thus charging the surface of the image bearing member, has been proposed. In such a charging apparatus, the magnetic material sealing member is also effective as a means for preventing leakage from lengthwise ends of the magnetic particle carrying member.

An example of a conventional magnetic material sealing member used in the conventional developing apparatus is shown in FIG. 24.

Referring to FIG. 24, at both ends of a developing roller 150 as the developer carrying member, a magnetic material sealing member 151 is disposed. Each magnetic material sealing member 151 is disposed opposite to an outer peripheral surface of the developing roller 150 with a predetermined gap g1. At an inner peripheral surface (opposite to the outer peripheral surface of the developing roller 150) of the magnetic material sealing member 151, a magnetic pole is disposed in a circumferential direction and creates a magnetic brush at the gap g1, thus preventing toner (developer) from leaking from the lengthwise ends of the developing roller 150.

FIG. 25 is a perspective view showing a detailed structure of the magnetic material sealing member 151. As shown in FIG. 25, the magnetic material sealing member 151 includes an arcuate portion 151a (half-round portion) providing the gap g1 (shown in FIG. 24) with the developing roller 150 at its inner peripheral surface, and an end portion (non-arcuate portion) 151b which extends linearly upward from an upper end of the arcuate portion 151a and has a rectangular cross section. On the end portion 151b, an arcuate surface 151c is formed and flush with a retracted front surface 151d and a bent portion which has a rectangular cross section extending in a lengthwise direction (axis direction) of the developing roller 151. The end portion 151b and the bent portion 151e are disposed perpendicular to each other, and the bent portion 151e extends in a direction of the end of the developing roller.

The magnetic material sealing member 151 is provided with an elastic lining 152 formed of an elastic material such as a rubber on an outer peripheral surface side (backside). The elastic lining 152 has a width substantially equal to that of the magnetic material sealing member 151 in a direction parallel to the lengthwise direction of the developing roller. A lower end surface 152f of the elastic lining 152 is substantially flush with a lower end surface 151f of the magnetic material sealing member 151, and an upper end surface 152g of the elastic lining 152 is substantially flush with an upper end surface 151g of the magnetic material sealing member 151.

The elastic lining 152 is adhered to the backside of the magnetic material sealing member 151 with the use of double-faced adhesive tape.

Next, a mounting method of the magnetic material sealing member 151 to a developing means frame 153 will be described.

Further, the developing means frame 153 is provided with a mounting groove 154 for mounting the magnetic material sealing member 151, which groove extending from a flat surface 153i to an arcuate surface 153j as shown in FIG. 26. The groove 154 includes an arcuate groove 154a extended along an arcuation of the arcuate surface 153j, a linear groove 154b formed substantially vertically along the flat surface 153j, and a positioning groove 154d, formed in the longitudinal direction of the magnetic material sealing member 151, with which the bent portion 151e of the magnetic material sealing member 151 is engaged. A depth of the positioning groove 154d is equal to a width w1 (FIG. 25) of the bent portion 151e of the magnetic material sealing member 151. A depth of the linear groove 154b for mounting the end portion 151b (FIG. 25) of the magnetic material sealing member 151, smaller than the width w1 of the bent portion 151e plus the thickness of the elastic lining 152 by a compression margin of the elastic lining 152. Further, a lower end surface 154f and an upper end surface 154g of the arcuate groove 154a are located so that they contact the lower end surface 151f and the upper end surface 151g of the magnetic material sealing member 151, respectively, in a state that the magnetic material sealing member 151 is engaged in the mounting groove 154 for mounting the magnetic material sealing member 151.

As shown in (a) of FIG. 27, the magnetic material sealing member 151 is moved to the mounting groove 154 of the developing means frame 153 as indicated by an arrow b. Then, the semicircular arcuate portion 151a of the magnetic material sealing member 151 is fitted into the arcuate groove 154a, and the linear end portion 151b is fitted into the linear groove 154b, as shown in (b) of FIG. 27. When the magnetic material sealing member 151 is pressed in a direction of an arrow c, a lower portion 152a of the elastic lining 152 is compressed. At the same time, the lower end surface 151f of the magnetic material sealing member 151 presses the lower end surface 154f of the groove 154, and an upper end surface 151g of the magnetic material sealing member 151 is fitted to an upper end surface 154g of the groove 154. Accordingly, when the upper portion of the magnetic material sealing member 151 is pushed toward the rear side in a direction of an arrow d crossing the arrow c, the magnetic material sealing member 151 is engaged with the mounting groove 154.

After the magnetic material sealing member 151 is mounted into the mounting groove 154, as shown in (a) of FIG. 28, a developing blade 155 as a developer regulation member for regulating a toner layer thickness on the developing roller 150 is a fastened to the developing means frame 153 with screws. The developing blade 155 includes an elastic member 155a and a supporting plate 155b. The elastic member 155a abuts on the developing roller 150 while being curved. The magnetic material sealing member 151 is urged toward the supporting plate 155b side o the developing blade 155 by a repulsive force of the elastic lining 152.

In order to to prevent leak between the magnetic material sealing member 151 and the supporting plate 155b of the developing blade 155, a non-electroconductive insulating member 56 is disposed therebetween so as to ensure electric insulation.

Alternatively, as shown in (b) of FIG. 28, the supporting plate 155b and the magnetic material sealing member 151 are caused to contact each other and an electroconductive member 157 is disposed between the developing roller 150 and the supporting plate 155b are connected, thus being placed in an electrically equipotential state. As a result, the leak phenomenon is prevented.

However, in the conventional developing apparatus using the magnetic material sealing member, the mounting of the magnetic material sealing member to the developing means frame requires such procedual steps that the magnetic material sealing member is rotated in a direction of an arrow e shown in (b) of FIG. 27 until the lower end surface 151f of the magnetic material sealing member contacts the lower end surface 154f of the mounting groove by applying a force not less than the sum of the repulsive force by the elastic lining and the frictional force with the developing means frame, and then is lightly pressed in the direction of the arrow c to somewhat deform the developing means frame and at the same time is pressed in the direction of the arrow d. Accordingly, the mounting of the magnetic material sealing member is accompanied with a poor workability.

The workability is also lowered by the adhesion operation of the elastic lining to the semicircular arcuate portion 151a.

Further, it is necessary to use the insulating member 156 only for the purpose of leak prevention or the electroconductive member 157 only for providing equipotential to the magnetic material sealing member 151, the developing blade 155, and the developing roller 150. As a result, the number of constituent parts is increased and the structure of the developing apparatus becomes complicated.

### SUMMARY OF THE INVENTION

In view of the above described problems, the present invention has been accomplished.

An object of the present invention is to provide a developing apparatus capable of improving mounting workability and a magnetic material sealing member used in the developing apparatus.

Another object of the present invention is to provide capable of solving a leak problem without using parts only for the purpose of leak prevention, and a magnetic material sealing member used in the developing apparatus.

According to the present invention, there is provided a developing apparatus, comprising:
a developing container for containing a developer;
a developer carrying member while carrying the developer thereon, the developer carrying member being provided in an opening portion of the developer container; and
a sealing member which extends in a circumferential direction of the developer carrying member in the vicinity of an end of the developer carrying member and regulates movement of the developer toward the end of the developer carrying member by a magnetic force, the sealing member including an arcuate portion extended along a peripheral surface of the developer carrying member and a non-arcuate portion disposed at an end, in the circumferential direction, of the arcuate portion;
wherein an end surface of the arcuate portion of the sealing member on a side where the non-arcuate portion is not provided, is inclined such that a phantom plane including the end surface is closer to the arcuate portion than a center of arcuation of the arcuate portion.

According to the present invention, there is also provided a sealing member for sealing magnetic particles, comprising:
an arcuate portion extended opposite to a peripheral surface of a rotation member for carrying magnetic particles,
a non-arcuate portion disposed at an end, in the circumferential direction, of the arcuate portion;
wherein an end surface of the arcuate portion of the sealing member on a side where the non-arcuate portion is not provided, is inclined such that a phantom plane including the end surface is closer to the arcuate portion than a center of arcuation of the arcuate portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an electrophotographic image forming apparatus, in which a process cartridge in accordance with the present invention has been mounted, describing the general structure thereof.

FIG. 2 is a schematic sectional view of the process cartridge describing the structure thereof.

FIG. 3 is an exploded perspective view of the developing apparatus of the present invention.

FIG. 4 is another exploded perspective view of the developing apparatus of the present invention.

FIG. 5 is an exploded perspective view of the drum frame unit of the process cartridge in accordance with the present invention.

FIG. 6 is a perspective view of a cleaning apparatus.

FIG. 7 is a perspective view of the cleaning apparatus.

FIGS. 8(a), (b) and (c) are explanatory views of the magnetic material sealing member of the present invention.

FIGS. 9(a) and (b) are views for illustrating a positional relationship between a magnet and a magnetic plate of the magnetic material sealing member.

FIGS. 10(a) and (b) are perspective explanatory views of the magnetic material sealing member.

FIGS. 11(a) and (b) are perspective explanatory views of a mounting portion of the magnetic material sealing member.

FIGS. 12(a) and (b) are sectional views for illustrating a mounting method of the magnetic material sealing member.

FIG. 13 is a perspective explanatory view of a magnetic material sealing member mounting portion of a first developing means frame.

FIG. 14 is a schematic sectional view of the magnetic material sealing member for illustrating a frame abutting surface in a plane perpendicular to a lengthwise direction of the frame body.

FIG. 15 is a perspective view showing a separation state of the developing apparatus and the cleaning apparatus.

FIG. 16 is a perspective view showing a connection state of the developing apparatus and the cleaning apparatus.

FIGS. 17(a) and (b) are explanatory side views of the process cartridge.

FIG. 18 is a drawing for describing a process cartridge mounting guide of a main assembly of the image forming apparatus.

FIG. 19 is a drawing for describing a process cartridge mounting guide of a main assembly of the image forming apparatus.

FIG. 20 is a perspective view of a magnetic material sealing member according to Embodiment 2 described later.

FIG. 21 is an explanatory sectional view showing a state that an elastic member is adhered to the magnetic material sealing member according to Embodiment 2.

FIG. 22 is an explanatory view showing a state of occurrence of a magnetic field at the magnetic material sealing member of Embodiment 2.

FIG. 23 is a schematic sectional view showing a positional relationship of the magnetic material sealing member of Embodiment 2, an elastic member, and a plate portion of a developing blade.

FIG. 24 is a perspective view of a conventional magnetic material sealing member describing the general structure thereof.

FIG. 25 is a perspective view of the conventional magnetic material sealing member describing the detailed structure thereof.

FIG. 26 is a detailed perspective view showing the conventional magnetic material sealing and a developing means frame.

FIGS. 27(a) and (b) are schematic sectional views for illustrating a mounting method of the conventional magnetic material sealing member.

FIGS. 28(a) and (b) are schematic sectional views for illustrating a conventional method of preventing leak phenomenon.

### DESCRIPTION OF THE PREFERRED EMBODIMENTS

Hereinafter, embodiments of the present invention, will be described in more detail with reference to the appended drawings.

In the following description of the present invention, the lengthwise direction of a process cartridge means the direction (axial direction of an image bearing member) intersectional (roughly perpendicular) to the direction in which a process cartridge is mounted into, or removed from, the main assembly of an image forming apparatus. It is parallel to the surface of recording medium, and is intersectional (roughly perpendicular) to the direction in which the recording medium is conveyed. The right or left direction means the right or left direction of the recording medium as the recording medium is seen from the rear side in terms of the recording medium conveyance direction. The top surface of a process cartridge means the surface of the process cartridge which will be on the top side after the proper mounting of the process cartridge in the main assembly of an image forming apparatus, and the bottom surface of the process cartridge means the surface of the process cartridge which will be on the bottom side after the proper mounting of the process cartridge in the apparatus main assembly.

[Embodiment 1]

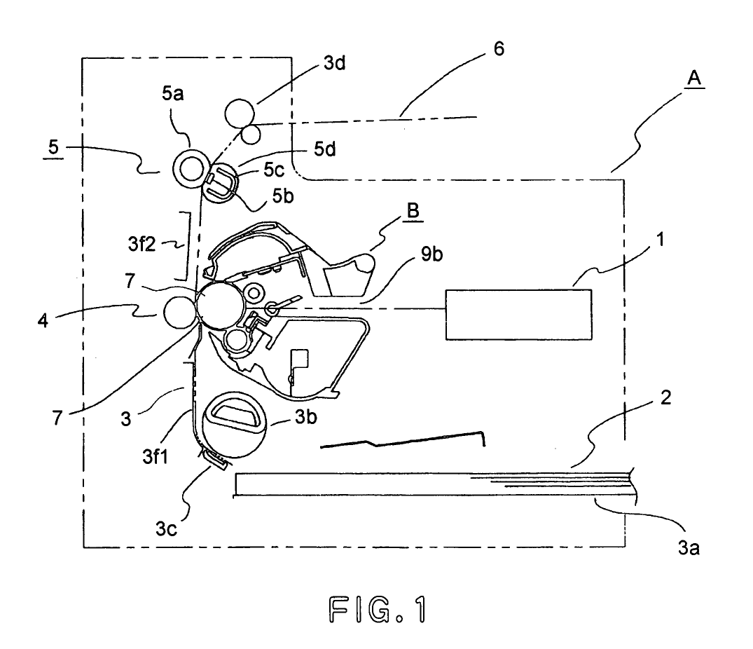

Embodiment 1 will be described with reference to FIGS. 1 and 2.

FIG. 1 is a schematic drawing for describing the structure of tan electrophotographic image forming apparatus, in which a process cartridge is mounted. FIG. 2 is a schematic drawing for describing the structure of the process cartridge.

As for the order of description, the general structure of the process cartridge and the general structure of the electrophotographic image forming apparatus employing the process cartridge will be first described. Then, the detailed structure of the developing apparatus according to the present invention will be described.

(General Structure)

Referring to FIG. 1, the electrophotographic image forming apparatus A (which hereinafter will be referred to simply as “image forming apparatus”) in this embodiment is a laser beam printer, and has an electrophotographic photosensitive member 7 in the form of a drum (which hereinafter will be referred to simply as “photosensitive drum”), as an image bearing member.

A beam of light carrying image formation information is projected onto the photosensitive drum 7 from an optical system (exposure apparatus) 1, forming a latent image on the photosensitive drum 7. This latent image is developed into a toner image with the use of developer (which hereinafter may be referred to as “toner”).

In synchronism with the formation of the toner image, a single or plurality of sheets of recording medium 2 (recording sheet, OHP film, cloth, etc.) in a sheet feeder cassette 3a are fed one by one into the apparatus main assembly by the combination of a pickup roller 3b, and a pressing member 3c kept pressed against the pickup roller 3b, and are conveyed further inward along a conveying guide 3f1.

The toner image formed on the photosensitive drum 7 in a process cartridge B is transferred onto the recording medium 2 by applying voltage to a transfer roller 4 as a transferring means. Then, the recording medium 2 is conveyed to a fixing means 5 by a conveying guide 3f2.

The fixing means 5 comprises: a driving roller 5a, a heater 5b, a supporting member 5c, and a rotational fixing member 5d. The rotational fixing member 5d is a cylinder formed of sheet of a certain substance, and is supported by the supporting member 5c. The heater 5b is in the hollow of the rotational fixing member 5d. The fixing means 5 fixes the unfixed toner image on the recording medium 2 to the recording medium 2, by the application of heat and pressure to the recording medium 2 while the recording medium 2 is passed through the fixing means 5. After the fixation, the recording medium 2 is further conveyed and discharged into the delivery area 6 through a reverse conveyance passage, by a pair of discharge rollers 3d.

In this embodiment, a conveyance means 3 is constituted by the pickup roller 3b, the pressing member 3c, the discharge rollers, etc.

(Process Cartridge)

On the other hand, the process cartridge B comprises an electrophotographic photoconductive member, and a minimum of one processing means. As for the processing means, there are, for example, a charging means for charging the electrophotographic photoconductive member, and a developing means for developing a latent image formed on the electrophotographic member, and a cleaning means for cleaning the toner remaining on the electrophotographic photosensitive member.

Referring to FIGS. 1 and 2, the process cartridge B in this embodiment comprises the photosensitive drum 7, as an electrophotographic photosensitive drum, having a photoconductive layer, a charge roller 8 as a charging means, a developing means 10, and an exposure opening 9. In operation, while the photosensitive drum 7 is rotated, the peripheral surface of the photosensitive drum 7 is uniformly charged by the application of voltage to the charge roller 8, and the uniformly charged portion of the peripheral surface of the photosensitive drum 7 is exposed to information light (an optical image) projected from the optical system 1, forming a latent image. Then, the latent image is developed by the developing means 10.

(Developing Apparatus)

The developing apparatus D incorporated into the process cartridge B will be described with reference to FIGS. 2-4.

The developing apparatus D incorporated into the process cartridge B will be described with reference to FIGS. 2-4.

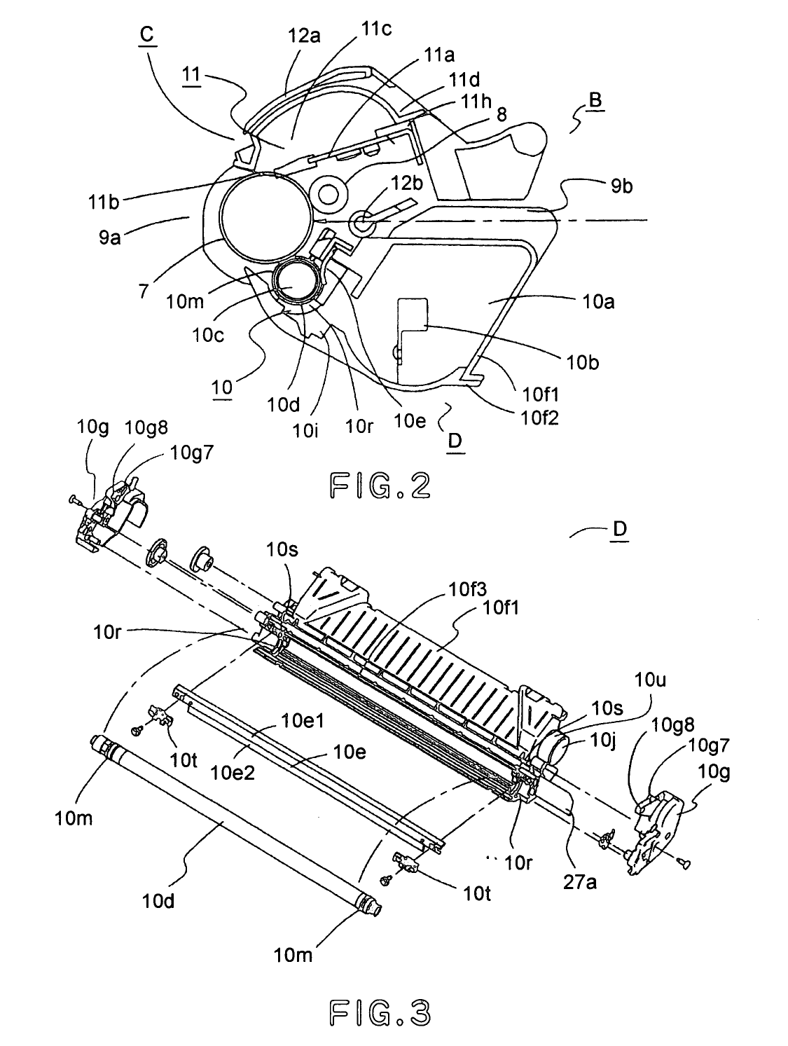

The developing apparatus D includes, as shown in FIG. 3, a first developing means frame 10f1 forming a toner storage portion 10a, a second developing means frame 10f2, an end member 10g, parts for supplying power to a developing roller 10d as a developer carrying member, the developing roller 10d, a developing blade 10e as a developer regulation member for regulating a thickness of a layer of developer on the developing roller 10d, a magnetic material sealing member 10r for preventing toner from leaking from both end portions of the developing roller 10d, etc.

In the developing apparatus, toner stored in the toner storage portion is fed by a rotatable feeding member 10b as a toner feeding means. Then, the developing roller 10d containing a fixed magnet 10c is rotated and a layer of triboelectrically charged toner is formed on the surface of the developing roller 10d. The toner is then transferred onto the surface of the photosensitive drum in the pattern of the latent image to develop the latent image into a visual image, i.e., a toner image.

The first developing means frame 10f1 is rotatably supported by a cleaning means frame 11d so that the developing roller 10d of the developing apparatus D is oppositely disposed in parallel with the photosensitive drum 7 with a predetermined gap, and a gap-holding member 10m for holding the gap between the developing roller 10d and the photosensitive drum 7 is disposed at both end portions of the developing roller 10d.

Further, as shown in FIG. 3, at both side surfaces of the first developing means frame 10f1, the end member (holder member) 10g is disposed. The end member 10g is provided with an arm portion 10g7 having an engaging hole for rotatably hanging the developing means frame 10f1 with respect to the cleaning apparatus described later.

The toner storage portion 10a and a developing chamber 10i are formed by connecting the first developing means frame 10f1 and the second developing means frame 10f2 to each other. The developing means frame according to the present invention comprises the first developing means frame 10f1 and the second developing means frame 10f2.

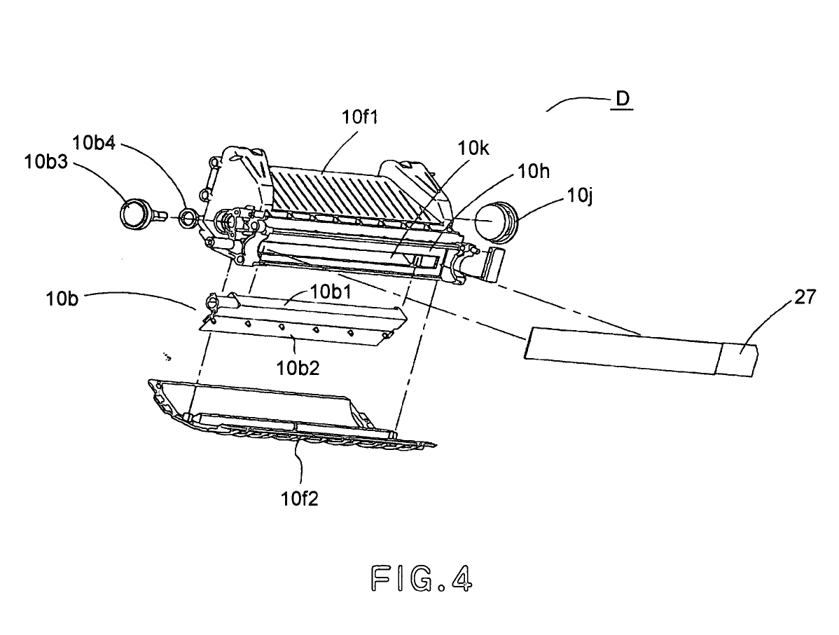

The first developing means frame 10f1 includes, as shown in FIG. 4, a stirring shaft 10b1 for supplying the toner and a sheet member 10b2 fixed to the stirring shaft 10b1. At an end of the stirring shaft 10b1, a conveyance gear 10b3 for regulating movement of the stirring shaft 10b1 in a lengthwise direction and receiving a driving force, and a sealing member 10b4 for preventing the toner from leaking toward the outside of the first developing means frame 10f1 are connected to the stirring shaft 10b1.

The first developing means frame 10f1 is provided with a toner passage opening 10k through which the toner stored in the toner storage portion 10a passes at the time of being fed to the developing roller 10d.

Further, as shown in FIG. 4, a toner sealing member 27 is heat-fixed to a seal mounting portion 10h along four edges of the toner passage opening 10k. At one end portion of the first developing means frame 10f1 in the lengthwise direction, as shown in FIG. 3, a toner filling port 10u for filling toner in the toner storage portion 10a is disposed and sealed with a cap member 10j after toner filling.

The developing apparatus D feeds the toner stored in the toner storage portion 10a by the feeding member 10b and forms a toner layer on the developing roller 10d by a magnetic force of the fixed magnet 10e, followed by development of the latent image formed on the photosensitive drum 7 with the toner by application of a developing bias voltage to form a visual (toner) image.

This toner image is transferred onto the recording medium 2 by applying a voltage of a polarity opposite to that of the toner image to the transfer roller 4.

The structure of the toner sealing member at the ends of the developing roller 10d in the lengthwise direction will be described in detail later.

(Cleaning Apparatus)

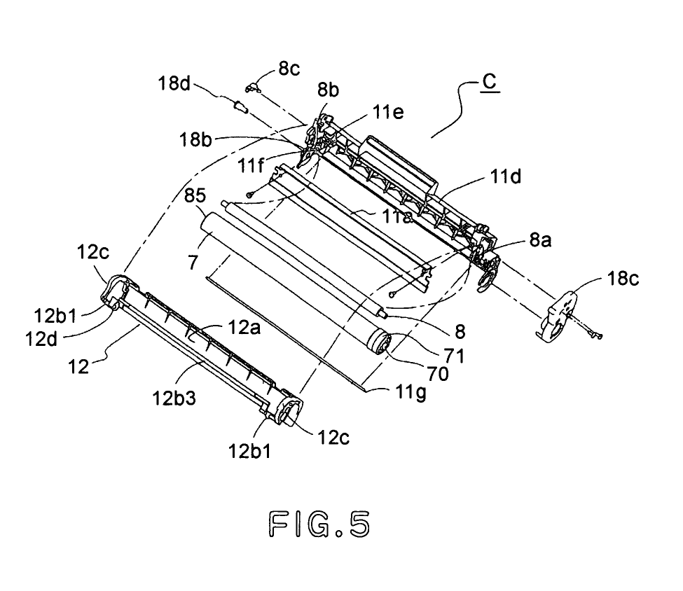

A cleaning apparatus C will be described in detail with reference to FIGS. 2, 5, 6 and 7.

The toner image developed by the developing means as described above is transferred onto the recording medium at the developing portion. The toner remaining on the photosensitive drum after the transfer is removed and recovered by the cleaning means 11 by scraping the toner with a cleaning blade 11a and scooping the toner with a scooping sheet 11b to be collected in a removal toner storage portion 11c.

The cleaning means 11 is a means for removing and recovering the toner remaining on the photosensitive drum 7 after the transfer operation. As the removal means, the cleaning blade 11a, the scooping sheet 11b, and the removal toner storage portion 11c described above are used. As the recovery means, a first sealing member 11e for preventing leakage of the toner from the backside of the cleaning blade 11a at both end portions and a second sealing member 11h for preventing the toner leakage from the backside of the cleaning blade 11a are fixed at a predetermined position of the cleaning means frame 11d with double-faced adhesive tape or the like.

Then, the cleaning blade is fixed at a predetermined position of the cleaning means frame 11 d with screws. Further, a third sealing member 11f for preventing the toner leakage from both ends of a rubber of the cleaning blade 11a and being as a wiping member for wiping attachments such as toner particles on the photosensitive drum, and the scooping sheet 11b are adhesively fixed to the cleaning means frame 11d with double-faced adhesive tape or the like.

The cleaning apparatus C includes the above mentioned cleaning means 11, the photosensitive drum 7, a drum shutter 12, an electrode 8a for supplying a voltage from the main assembly of the image forming apparatus A to a charge roller 8, a roller bearing 8b for supplying a voltage to the charge roller 8 through the electrode 8a, the other roller bearing 8a, etc.

The electrode 8c is engaged in the cleaning means frame 11d, and the roller bearings 8a and 8b are incorporated in the cleaning means frame 11d. Further, a shaft portion of the charge roller 8 is engaged in the bearings 8a and 8b.

In this embodiment, the process cartridge B includes the cleaning apparatus C for rotatably supporting the photosensitive drum and the developing apparatus D for developing the latent image on the photosensitive drum into a visual image.

Between the developing apparatus D and the cleaning apparatus C, a predetermined pressing force is exerted for keeping a spacing.

The photosensitive drum 7 is connected, at one end, with a drum gear 71 integrally including a triangular coupling portion 70 for transmitting a driving force, gears for transmitting a driving force to the developing roller 10 and the transfer roller 4, an earth contact, etc., and, at the other end, is connected with a flange 85 having a bearing.

On the triangular coupling portion 70 side of the cleaning means frame 11d, a bearing 18c for the photosensitive drum 7 is connected with screws. Into the other side of the cleaning means frame 11d, a positioning pin 18d is inserted and held under pressure so as to be fitted in a positioning portion 18b.

In the process cartridge B of this embodiment, as shown in FIG. 2, the drum shutter 12 capable of integrally covering a transfer opening 9a and an exposure opening 9b disposed opposite to the transfer roller 4 for the photosensitive member 7 is provided rotatably to the cleaning means frame 11d.

(Drum Shutter)

The structure of the drum shutter 12 will be described.

The drum shutter 12 has a drum protection portion 12a capable of covering the transfer opening 9a where the photosensitive drum 7 contacts the transfer roller 4. To a rotation shaft 12b (FIG. 2) for rotatably supporting the drum shutter 12 in the vicinity of the charge roller 8 of the cleaning means frame 11d, sliding portions 12b1 which slide along the cleaning means frame 11d at both ends of the rotation shaft 12b and a connecting portion 12b3 for connecting the sliding portions is provided.

The drum shutter 12 has coupler portions 12c disposed at longitudinal ends each at which the end portions of the drum protection portion 12a and the rotation shaft 12b are connected. A rib 12e is disposed outside of the rotation shaft 12b1 and provided to the right-side coupler portion 12c (FIG. 7). The rib 12e extends outward in the lengthwise direction of the drum shutter 12 and is carried by a shutter guide surface of the image forming apparatus main assembly, thus being retained in an open state.

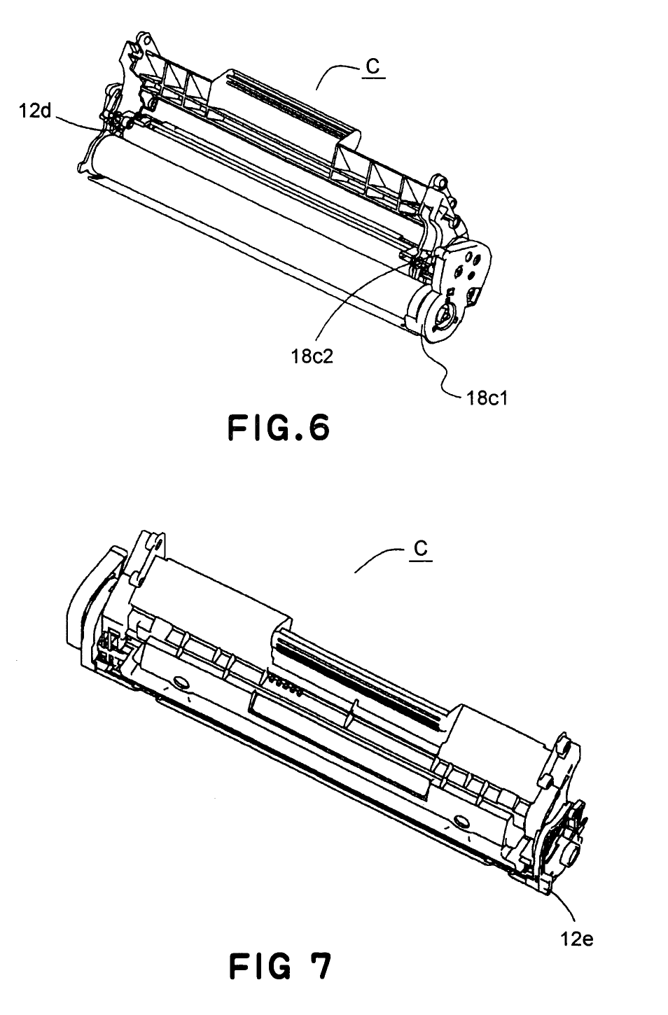

To the drum shutter, an urging force is applied by a spring force of a shutter spring 12d in a direction such that the drum shutter 12 covers the photosensitive drum 7. By doing so, in such a state that the process cartridge B is removed from the apparatus main assembly, the drum shutter 12 is retained in such a closed state as shown in FIGS. 6 and 7 that it covers the transfer opening 9a of the photosensitive drum. On the other hand, in such a state that the process cartridge B is capable of effecting image forming operation in the apparatus main assembly, the drum shutter is rotated by a drum shutter opening/closing means on the image forming apparatus main assembly side to expose the transfer opening 9a as shown in FIGS. 1 and 2. As a result, the photosensitive drum 7 and the transfer roller 4 are placed in a contactable state.

(Magnetic Material Sealing Member in Display Apparatus and Mounting Method Thereof)

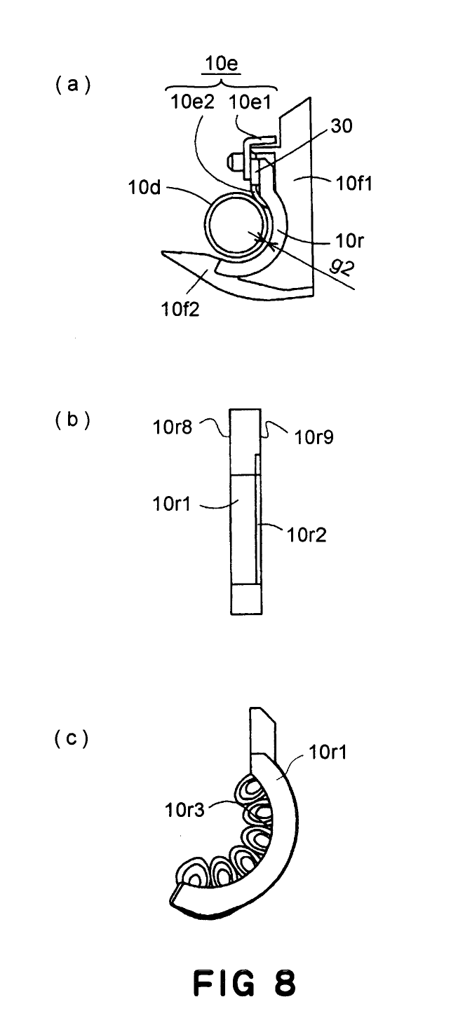

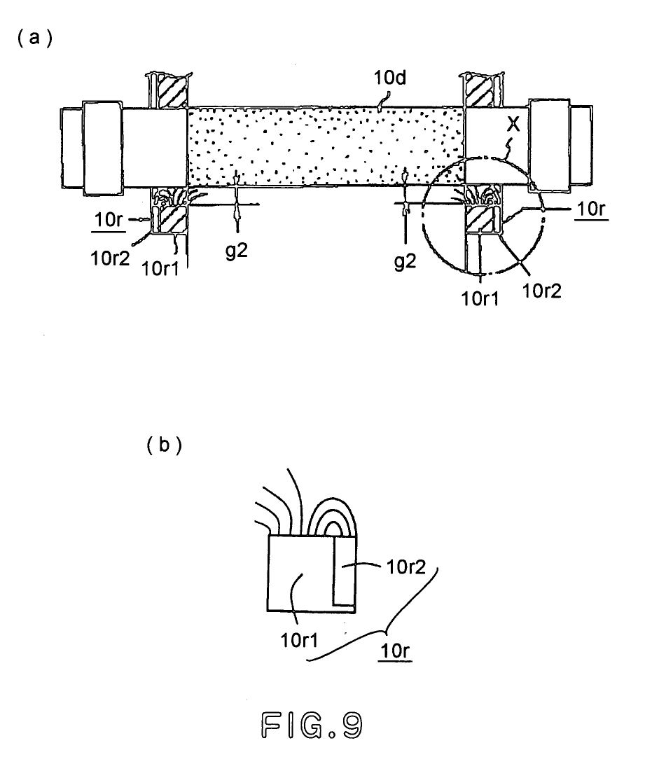

The structure of the magnetic material sealing member for preventing toner leakage in the above described developing apparatus D will be described FIGS. 8-13. FIG. 8(a) is a sectional view showing a positional relationship among the first developing means frame 10f1, the second developing means frame 10f2, the developing roller 10d, the elastic member 30, and the magnetic material sealing member 10r; FIG. 8(b) is a perspective view of the magnetic material sealing member 10r; and FIG. 8(c) is an explanatory view showing a state of generation of a magnetic field at the magnetic material sealing member 10r. FIG. 9(a) is a view showing a positional relationship between a magnet 10r1 and a magnetic plate 10r2, and FIG. 9(b) is a partially enlarged view of FIG. 9(a) at X portion.

As shown in FIG. 8(a), the magnetic material sealing member 10r1 is mounted to the first and second developing means frames 10f1 and 10f2 and creates a gap g2 with the developing roller 10d.

Further, as shown in FIG. 8(b), at a side surface of the magnet 10r1 of the magnetic material sealing member 10r in a width direction (i.e., the lengthwise direction of the developing roller 10d), the magnetic plate r2 of a magnetic material is bonded. The magnet 10r1 constituting the magnetic material sealing member 10r is a 2.5 mm-wide injection molding product comprising a nylon resin binder containing Nd—Fe—B magnetic material powder, and the magnetic plate 10r2 bonded to the magnet 10r1 is formed of an iron material in a thickness of 0.5 mm. Both members are bonded to each other through insert molding as a type of injection molding.

Further, as shown in FIG. 8(c), at the inner peripheral surface 10r3 (opposite to the outer peripheral surface of the developing roller) of the magnet 10r1, a plurality of N- and S-poles are provided, whereby a chain of the magnetic brush is formed at the gap g2 between the magnet 10r1 and the developing roller 10d, thus preventing the toner from leaking from the end portion of the developing roller 10d. In this embodiment, the gap g2 is set to 0.1-0.7 mm, and a magnetic flux density by a magnetic force of the magnetic material sealing member 10r is about 1000-2000 Gs on the developing roller 10d.

With respect to the positional relationship between the magnet 10r1 and the magnetic plate 10r2 in the magnetic material sealing member 10r, as shown in FIG. 9(a), the magnet 10r1 is disposed on the opening side of the first developing means frame 10f1, and the magnetic plate 10r2 is disposed on the outer side than the opening side (both end sides of the developing roller 10d in the lengthwise direction).

As described above, by disposing the magnet 10r1 on the opening side of the first developing means frame 10f1 and disposing the magnetic plate 10r2 on the outer side than the opening side, magnetic lines of force of the magnetic material sealing member 10r, as shown in FIG. 9(b), are created between the magnet 10r1 and the magnetic plate 10r2 and enter the magnetic plate 10r2 having a higher permeability, so that magnetic lines of force extending toward the outside of the magnetic material sealing member 10r are not generated. As a result, it becomes possible to reliably hold the toner in an area where the surface of the magnetic material sealing member 10r exhibits a strong magnetic force. Accordingly, even if, e.g., an impact is given when the process cartridge B is mounted in or demounted from the image forming apparatus main assembly by a user, it is possible to ensure a good sealing performance without causing toner leakage.

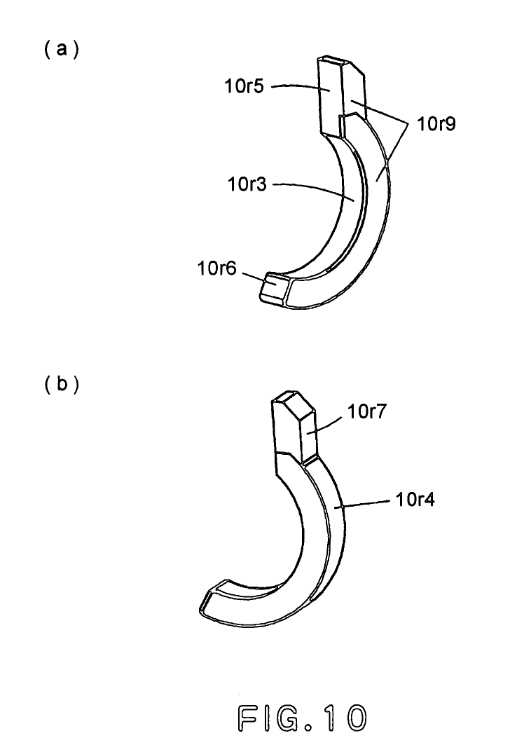

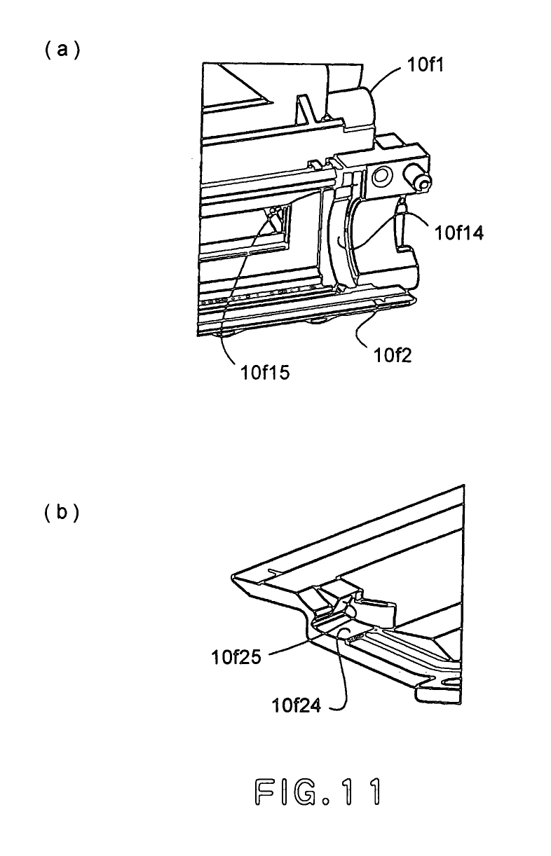

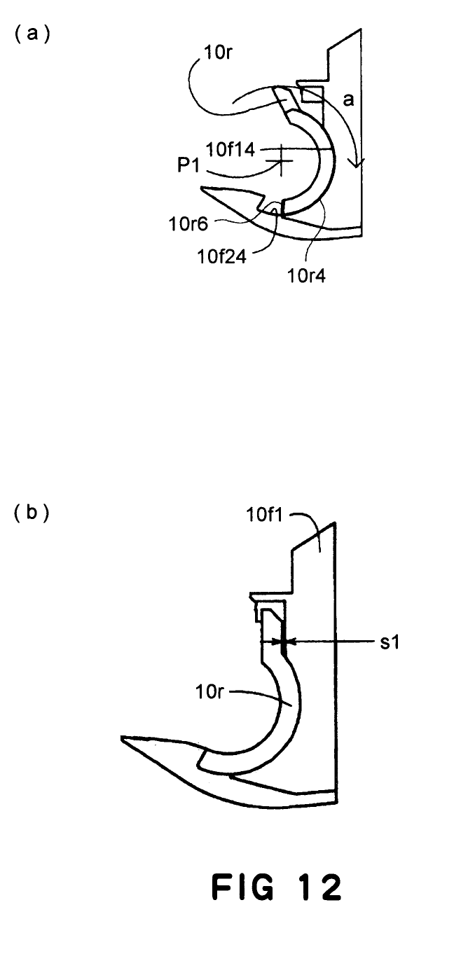

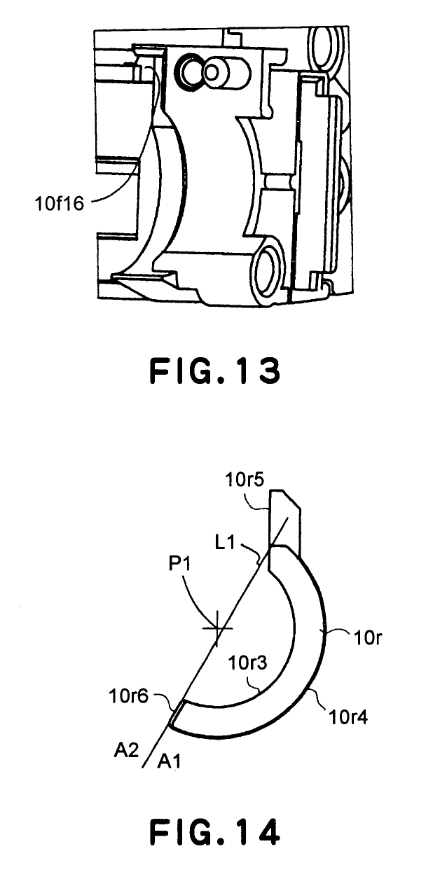

Then, the mounting method of the magnetic material sealing member 10r will be described with reference to FIGS. 8 and 10-14. FIGS. 10(a) and 10(b) are perspective explanatory views of the magnetic material sealing member 10r; FIGS. 11(a) and 11(b) are perspective explanatory views of mounting portions o the magnetic material sealing member 10r; FIGS. 12(a) an 12(b) are sectional explanatory views of the mounting method of the magnetic material sealing member 10r; FIG. 13 is a perspective explanatory view of the magnetic material sealing member mounting portion of the first developing means frame; and FIG. 14 is a sectional explanatory view or describing a frame abutting end surface 10r6 of the magnetic material sealing member 10r in a plane perpendicular to the lengthwise direction of the frame.

As shown in FIGS. 8(a) and 10(a), the magnetic material sealing member 10r has the inner peripheral surface (the developing roller 10d side) in the form of a semicircular arc for creating the gap g2 with the developing roller 10d, and an outer contact surface 10r4, in a semicircular arc, which contacts the first developing means frame 10f1 and the second developing means frame 10f2 on the outer peripheral surface side locate opposite from the inner peripheral surface 10r3 i.e., on the first and second developing means frame sides). The outer contact surface 10r4 is not provided with an elastic lining as in the conventional magnetic material sealing member but directly contacts grooves provided to the developing means frames.

Further, the magnetic material sealing member 10r has an elastic member abutting surface 10r5 (FIG. 10(a)) where a metal plate portion 10e1 (FIG. 8(a)) of the developing blade 10e attached to the first developing means frame 10f1 and the elastic member 30, which is to be compressedly disposed between the developing blade 10e and the magnetic material sealing member 10r, contact each other. As described above, the magnetic material sealing member 10r has the arcuate portions (10r3, 10r4) extended along the peripheral surface of the developing roller and the non-arcuate portions (10r5, 10r7) disposed on one end side of the arcuate portions.

Further, on the other end side where the non-arcuate portions are disposed, the magnetic material sealing member 10r has a frame abutting surface 10r6 (FIG. 10(a)) for contacting the second developing means frame 10f2.

On the other hand, the first developing means frame 10f1 is provided with a mounting arcuate portion 10f14 for contacting the outer contact surface 10r4 of the magnetic material sealing member 10r as shown in FIG. 11(a).

Further, as shown in FIG. 11(b), the second developing means frame 10f2 is provided with a mounting arcuate portion 10f24 for contacting the outer contact surface 10r4 of the magnetic material sealing member 10r and a mounting end surface 10f25 for abutting on the frame abutting surface 10r6 of the magnetic material sealing member 10r. The magnetic material sealing member 10r is mounted in such a state that the first and second developing means frames 10f1 and 10f2 are connected to each other as shown in FIG. 8(a) but in FIG. 11(b), only the second developing means frame 10f2 is shown for the sake of easy explanation of the mounting end surface 10f25, thus omitting the first developing means frame 10f1.

When the magnetic material sealing member 10r is mounted in the developing means frame comprising the first and second developing means frames 10f1 and 10f2, as shown in FIG. 12(a), the magnetic material sealing member 10r is placed on the mounting arcuate portion 10f14 of the first developing means frame 10f1 until the outer contact surface 10r4 contacts the mounting arcuate portion 10f14 and then is rotated in a direction of an arrow a.

Then, as shown in FIG. 12(b), when the magnetic material sealing member 10r is rotated until its frame abutting end surface 10r6 runs against the mounting end surface 10f25 of the second developing means frame 10f2, the magnetic material sealing member 10r is located at a predetermined position.

Incidentally, in order to avoid contact between a backside surface 10r7 of the elastic member abutting surface 10r5 and the first developing means frame 10f1, a spacing S1 is provided. The spacing S1 is set to a value capable of accommodating shape and dimension errors as production of the second developing means frame 10f2 and the magnetic material sealing member 10r.

Further, side surfaces 10r8 and 10r9 (FIG. 8(b)) of the magnetic material sealing member 10r are inserted in a space between positioning surfaces 10f15 and 10f16 (FIGS. 11(a) and 13) of the first developing means frame 10f1, whereby positioning of the magnetic material sealing member 10r in the lengthwise direction of the developing roller is effected.

Then, the elastic member 30 is disposed at the elastic member abutting surface 10r5 of the magnetic material sealing member 10r. he elastic member 30 is attached to the elastic member abutting surface 10r5 with the use of adhesive means such as double-faced adhesive tape.

A sealing member 10s (FIG. 3) for preventing toner leakage from both end portions of the developing blade 10e is attached to the first and second developing means frames 10f1 and 10f2.

Further, as shown in FIG. 3, the developing blade 10e is secured at both end portions of the metal plate portion 10e1 to the first developing means frame 10f1 together with a scraping member lot for scraping the toner at end portion of the developing roller 10d by screws. At this time, a tapered rib 10f3 disposed along the lengthwise direction of the first developing means frame 10f1 is set to have a dimension so that it always bites a developing blade rubber portion 10e2. As a result, the developing blade rubber portion 10e2 and the first developing means frame 10f1 are being left in a sealed state.

The thickness of the elastic member 30 is set to a value larger than an ordinary value by a compression margin in advance so as to create an elastic force at the magnetic material abutting surface 10r5 in such a state that the elastic member 30 is compressedly sandwiched between the metal plate portion 10e1 of the developing blade (layer thickness regulation member) 10e and the elastic member abutting surface 10r5 of the magnetic material sealing member 10r (FIG. 8(a)).

In this embodiment, a complicated operation as in the conventional developing apparatus is not required in the mounting step but a simple operation such that the magnetic material sealing member 10r is only rotated relative to the developing means frame (the first and second developing means frames) while contacting the developing means frame is effected.

A frictional resistance caused by friction between the developing means frame (polystyrene-based resin) and the magnetic material sealing member 10r is smaller than a resistance caused by compression and friction of the elastic lining as in the conventional developing apparatus. Further, the developing apparatus of the present invention is also advantageous than the conventional developing apparatus in terms of an operation force since the magnetic material sealing member can be mounted in the developing means frame without deforming the developing means frame.

By the elastic force caused by the elastic member 30, a rotational force is exerted on the magnetic material sealing member 10r in the direction of the arrow a. The frame abutting surface 10r6 for preventing rotation in the arrow a direction is press fitted in the developing means frame so that the outer contact surface 10r4 is not separated from the mounting arcuate portion 10f14 of the first developing means frame 10f1 and the mounting arcuate portion 10f24 of the second developing means frame 10f2 by the rotational force.

The above mounting method will be described more specifically with reference to FIGS. 12(a) and 14.

Referring to these figures, a rotation center at the time of rotating the magnetic material sealing member 10r in the arrow a direction is indicated as P1. This rotation center P1 corresponds to the center of arcuation of the outer contact surface 10r4. On the other hand, as shown in FIG. 14, an extension line of the frame abutting end surface 10r6 is indicated as L1, and two areas partitioned by the line L1 are indicated as A1 and A2. THe area A1 is located on the magnetic material sealing member 10r side, and the area A2 is located on the mounting end surface 10f25 side.

In this embodiment, the center P1 is located on the area A1 side, i.e., a phantom plane including the frame abutting end surface 10r6 is placed closer to the arcuate portion side than the center of arcuation of the arcuate portion of the magnetic material sealing member 10r, whereby the rotational force acts on the magnetic material sealing member 10r so that the magnetic material sealing member 10r is pressed toward the outer contact surface 10r4 side. Accordingly, the outer contact surface 10r4 of the magnetic material sealing member 10r is not separated from the mounting arcuate portions 10f14 and 10f24 of the first and second developing means frames 10f1 and 10f2. As a result, the gap g1 between the developing roller 10d and the magnetic material sealing member 10r is kept constant.

In the conventional developing apparatus, the elastic lining member is adhered to the outer peripheral surface of the arcuate portion of the magnetic material sealing member. On the other hand, in this embodiment, the elastic member 30 is adhered to a planar portion 10r5, so that an adhesive workability of the elastic member 30 is improved, thus facilitating a mounting performance.

Further, positioning of the magnetic material sealing member 10r is performed in a plane perpendicular to the lengthwise direction of the developing roller by the outer contact surface 10r4 and the frame abutting surface 10r6. Accordingly, it is not necessary to provide the magnetic material sealing member with a bent portion extending in the lengthwise direction of the developing roller as in the conventional developing apparatus. As a result, the developing device is made compact in the lengthwise direction and is also applicable to a developing means frame having a tight space in the lengthwise direction.

(Connection Between Developing Apparatus and Cleaning Apparatus)

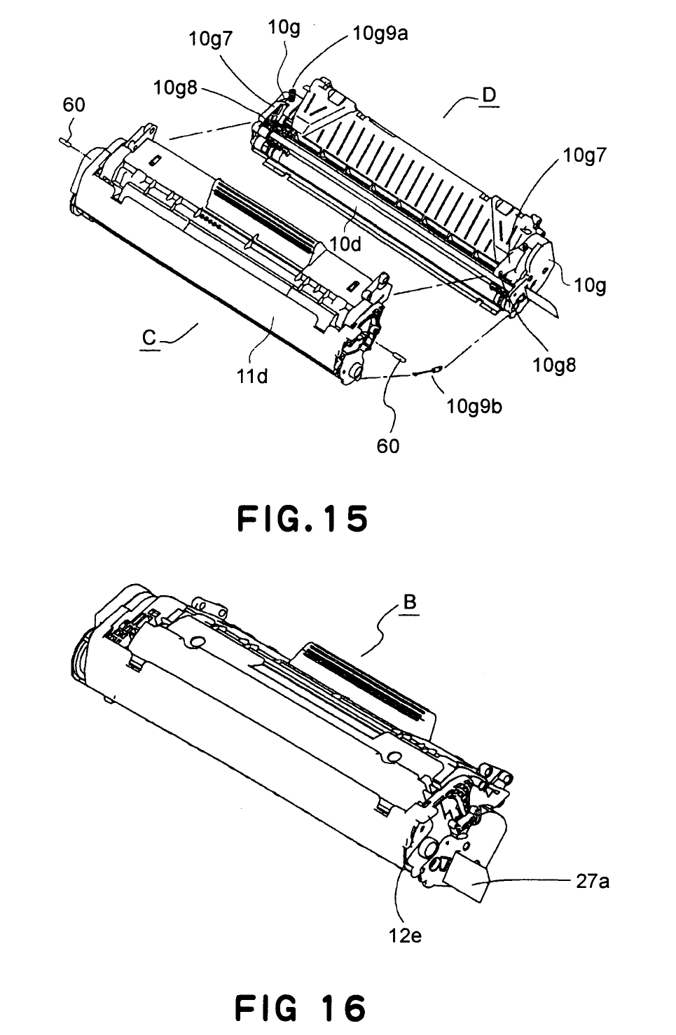

Connection of the above described developing apparatus D with the cleaning apparatus is performed in the following manner as shown in FIG. 15.

Referring to FIG. 15, each of two end members 10g provided to both ends of the developing means frame is provided with an arm-like portion 10g7, which protrudes toward the cleaning means frame 11d. The arm-like portion 10g7 has a hole 10g8, which is in the end portion of the arm-like portion 10g7, extending in the lengthwise direction of the process cartridge B. The cleaning means frame 11d and the end member 10g can be joined by putting a pin through the hole 10g8 of the arm-like portion of the end member 10g, and the unshown hole of the cleaning means frame 11d, so that they can be rotated about the pin. A compression coil spring 10g9a is placed in the compressed state between the arm-like portion 10g7 and cleaning means frame 11d, with one end of the compression coil spring 10g9a fitted around the spring holding portion 10g9 of the end member 10g and with the other end of a tension spring 10g9b having from the end member 10g to the cleaning means frame 11d. The end portions of the development roller 10d are fitted with gap maintaining members 10m, one for one, and the gap maintaining members 10m are pressed on the peripheral surface of the photoconductive drum 7. Therefore, a predetermined distance is kept between the peripheral surfaces of the developing roller and the photosensitive drum 7. The above described method completes the process cartridge B.

When a user purchases and uses the process cartridge B, the user holds and pulls out a toner sealing member end portion 27 to unseal the toner passage opening 10k of the first developing means frame 10f1, thus allowing feeding of the toner from the toner storage portion 10a to the developing chamber 10i. By doing so, the process cartridge B is ready for insertion thereof into the main assembly of the image forming apparatus A.

(Mounting and Demounting of Process Cartridge B, into and from, Image Forming Apparatus main Assembly)

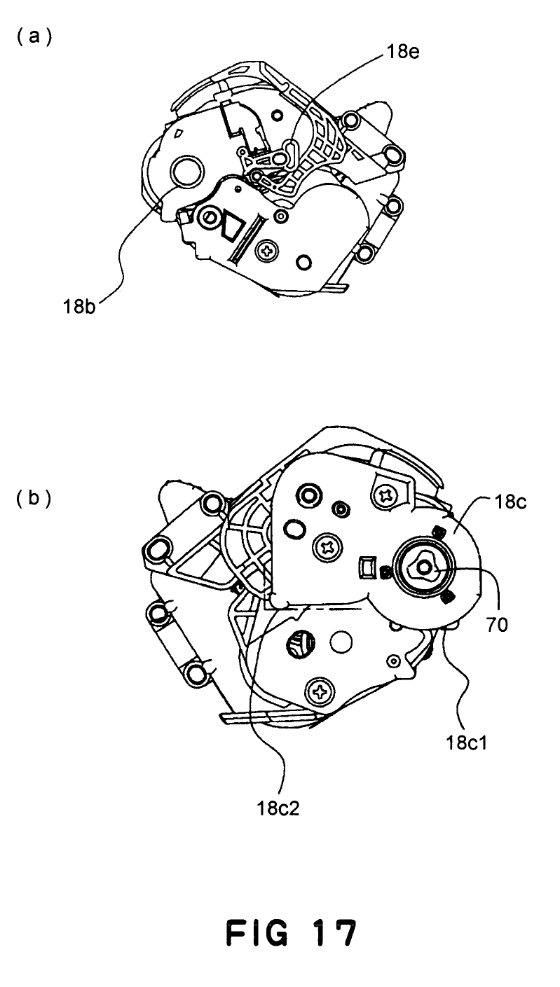

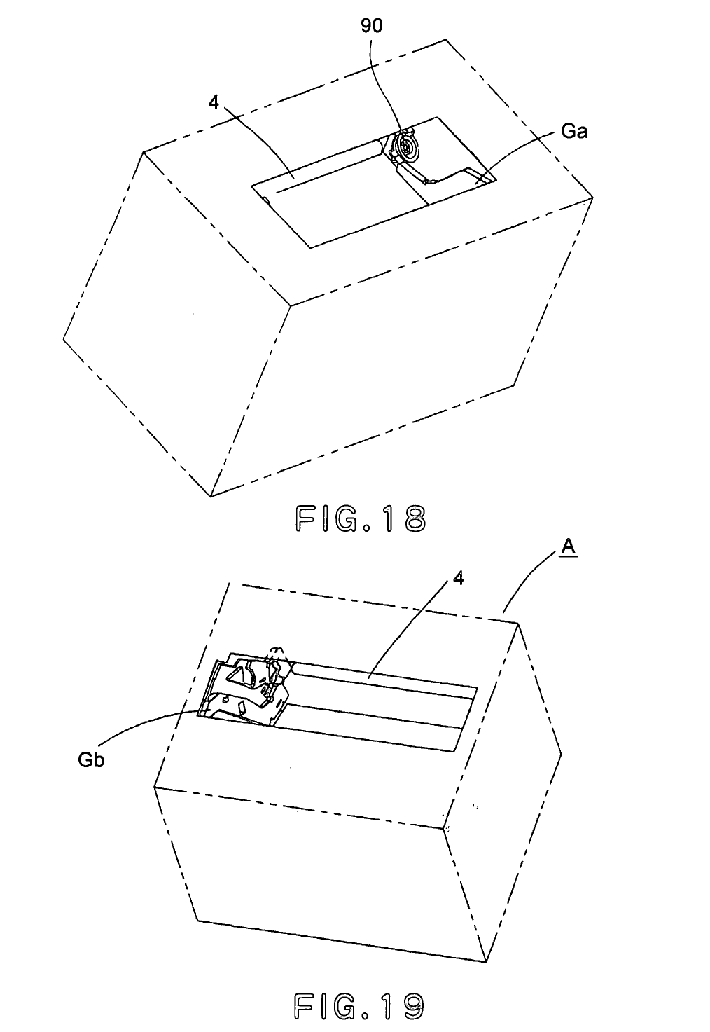

When the above assembled process cartridge B is mounted into and demounted (removed) from the main assembly of the image forming apparatus, as shown in FIGS. 17(a) and 17(b), an arcuate portion 10c1 and a rotation stopping portion 18c2 provided at one side surface of the process cartridge B (FIG. 17(b)) are guided along a guide member Ga (FIG. 18) as a mounting means provided to the apparatus main assembly, and a positioning portion 18b and a projection 18e provided at the other surface of the process cartridge B (FIG. 17(a)) are guided along a guide member Gb (FIG. 19). As a result, when the process cartridge B is mounted into the image forming apparatus main assembly, a triangular coupling portion 70 (FIG. 17(b)) is engaged with a driving force transmitting portion 90 (FIG. 18), thus allowing driving force transmission to the process cartridge B.

According to this embodiment, the magnetic material sealing member has the above described structure and mechanism, so that the following effects are achieved.

A complicated operation as in the conventional developing apparatus is not required in the mounting step but a simple operation such that the magnetic material sealing member 10r is only rotated relative to the developing means frame (the first and second developing means frames) while contacting the developing means frame is effected.

A frictional resistance caused by friction between the developing means frame and the magnetic material sealing member 10r is smaller than a resistance caused by compression and friction of the elastic lining as in the conventional developing apparatus. Further, the developing apparatus of the present invention requires less operation force, thus facilitating assembling properties.

By the elastic force caused by the elastic member 30, the outer contact surface 10r4 and the frame abutting surface 10r6 of the magnetic material sealing member 10r is press fitted in the developing means frame so that the magnetic material sealing member 10r is not separated from the developing means frame. Accordingly, the gap g1 between the developing roller 10d and the magnetic material sealing member 10r is kept constant thus improving the sealing performance of the magnetic material sealing member 10r.

In the conventional developing apparatus, the elastic lining member is adhered to the arcuate portion of the magnetic material sealing member but in this embodiment, the elastic member 30 is adhered to a planar elastic member abutting surface 10r5, so that an adhesive workability of the elastic member 30 is improved, thus facilitating a mounting performance.

Further, positioning of the magnetic material sealing member 10r is performed in a plane perpendicular to the lengthwise direction of the developing roller by the outer contact surface 10r4 and the frame abutting surface 10r6. Accordingly, it is not necessary to provide the magnetic material sealing member with a bent portion extending in the lengthwise direction of the developing roller as in the conventional developing apparatus. As a result, the developing device is made compact in the lengthwise direction and is also applicable to a developing means frame having a tight space in the lengthwise direction.

[Embodiment 2]

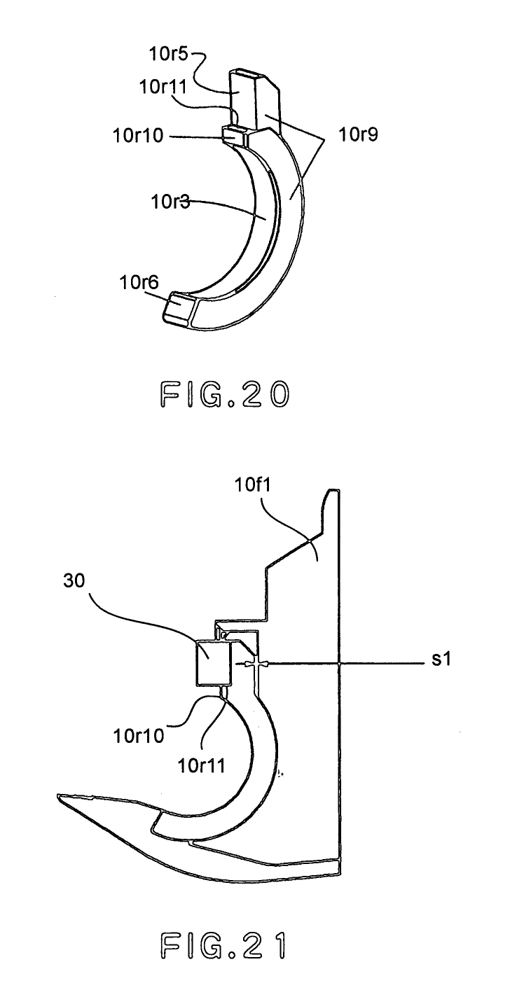

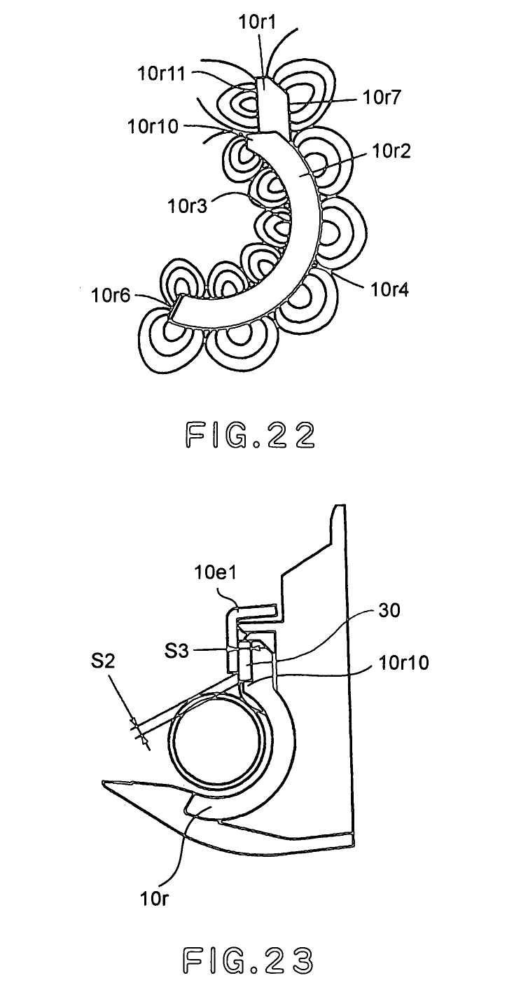

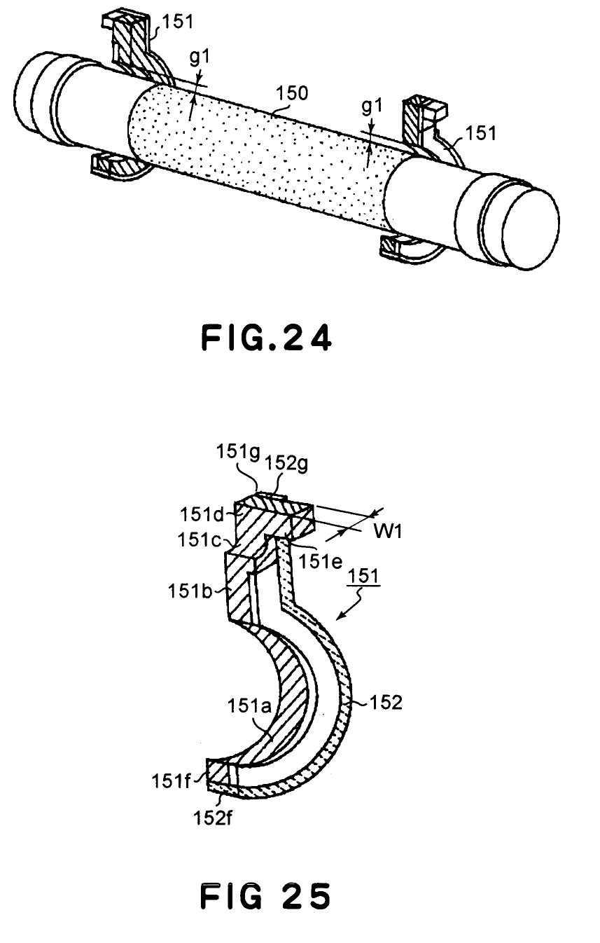

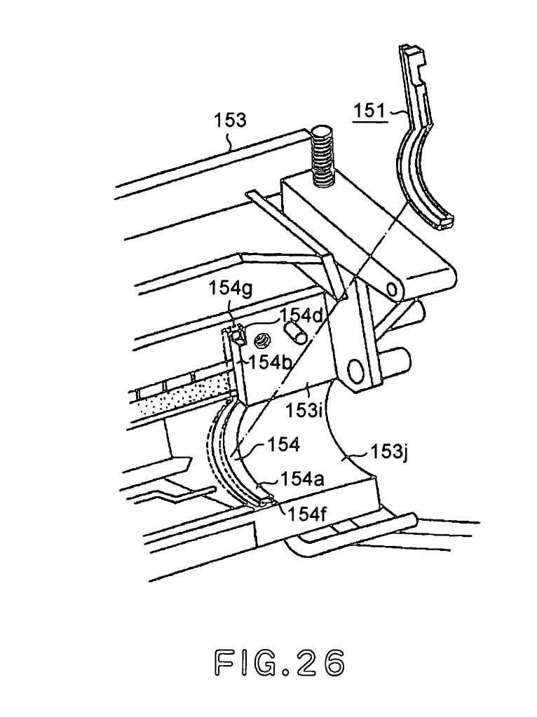

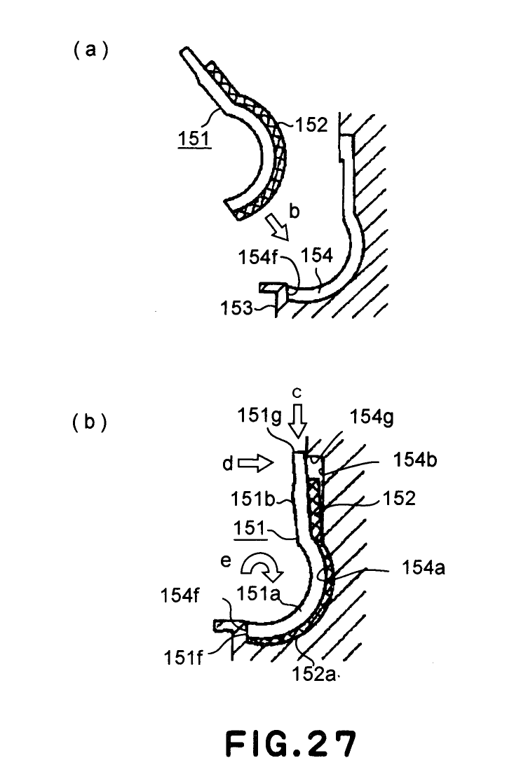

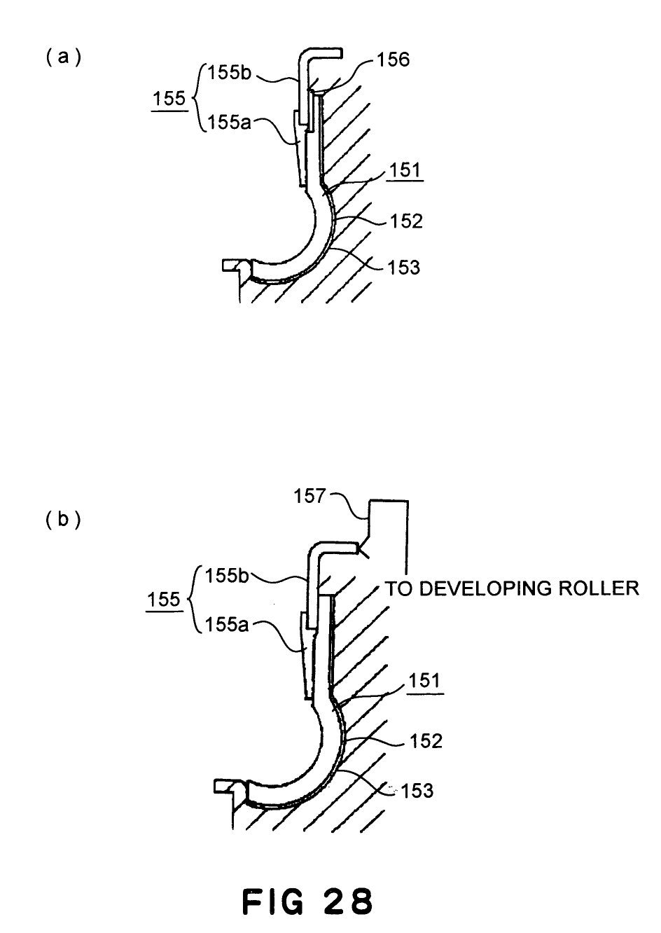

A second embodiment of the of the magnetic material sealing member according to the present invention will be described with reference to FIGS. 20-23. FIG. 20 is a perspective explanatory view of the magnetic material sealing member 10r; FIG. 21 is a sectional explanatory view showing a state such that an elastic member 30 is adhered to the magnetic material sealing member 10r; FIG. 22 is an explanatory view showing a state of generation of a magnetic field at the magnetic material sealing member 10r; and FIG. 23 is a sectional explanatory view showing a positional relationship among the magnetic material sealing member 10r, the elastic blade 30, and the metal plate portion 10e1 of the developing blade 10e. Identical reference numerals and sins are used for describing members (dimensions, directions, etc.) identical to those used in Embodiment 1 described above, and explanation thereof is omitted.

In this embodiment, as shown in FIGS. 20 and 21, a projection portion 10r10 which is protruded in a direction perpendicular to the elastic member abutting surface 10r5 is disposed between the inner peripheral surface 10r3 and the elastic member abutting surface 10r5 of the magnetic material sealing member 10r.

The projection portion 10r10 has a projection surface 10r11, which is substantially perpendicular to the elastic member abutting surface 10r5 and utilized as a striking surface at the time of adhesion of the elastic member 30 thereto, whereby a resultant positional accuracy for adhesion of the elastic member 30.

Further, as shown in FIG. 22, a inner peripheral surface opposite to the outer peripheral surface of the developing roller) of the magnet 10r1, the projection portion 10r10, the elastic member abutting surface 10r5, a backside surface 10r7 of the elastic member abutting surface 10r5, and the outer contact surface 10r4 are polarized to have a plurality of N- and S-poles. By polarizing the backside surface 10r7, a magnetic field is also created at minute gaps, caused by production-dimension error of the magnetic material sealing member 10r and the developing means frame (the first and second developing means frames 10f1 and 10f2), between the outer contact surface 10r4 and the mounting arcuate portion 10f14 of first developing means frame 10f1 and between the outer contact surface 10r4 and the mounting arcuate portion 10f24 of the second developing means frame 10f2. Further, also at the spacing S2 between the backside surface 10f7 and the first developing means frame 10f1, a magnetic field is created.

Accordingly, the toner leakage from the gaps (and spacing) between the magnetic material sealing member 10r an the developing means frame is prevented with reliability.

Further, an area of the inner peripheral surface is increased by providing the projection portion, a toner leakage preventing ability from the end portions of the developing roller 10d is further improved.

Next, countermeasure against leak will be described with reference to FIG. 23.

The magnetic material sealing member 10r is charged by a voltage supplied to the developing roller 10d or triboelectric charge with the toner present between the developing roller 10d and the magnetic material sealing member 10r, so that electric charges are accumulated. In such an electrically unstable state that the magnetic material sealing member 10r and the metal plate portion 10e1 of the developing blade 10e are electrically connected or disconnected, leak is caused to occur between the magnetic material sealing member 10r and the metal plate portion 10e1 of the developing blade 10e, whereby noise is liable to occur.

In this embodiment, the magnetic material sealing member 10r and the metal plate portion 10e1 are completely placed in a non-contact state. More specifically, minimum distances between the metal plate portion 10e1 of the developing blade 10e1 and the projection portion 10r10 and between the metal plate portion 10e1 of the developing blade 10e1 and the elastic member abutting surface 10r5 are set to s2 and s2, respectively, determined in view of variations in distance on production, and these distances are set to be larger than a leak limit distance in view of a voltage supplied to the developing roller 10d. As a result, direct leak from the magnetic material sealing member 10r to the metal plate portion 10e1 does not occur. Further, the elastic member 30 is electrically insulative (i.e., not electroconductive), thus causing no charge transfer therethrough.

As described above, according to this embodiment, it is possible to prevent noises caused by leak by making the elastic member 30 non-electroconductive without employing additional parts as countermeasure against leak. Accordingly, the developing apparatus of the present invention is advantageous in terms of production costs and assembly performance.

In the above described Embodiments 1 and 2, the developer is used as an example of the magnetic particles. However, the magnetic material sealing member of the present invention is also applicable to a magnetic material sealing member as a means for preventing leakage of the electroconductive magnetic particles from both ends of the magnetic particle carrying member in the conventional developing apparatus of the magnetic brush charging scheme using the electroconductive magnetic particles as described above. In also such a case, effects similar to those achieved in Embodiments 1 and 2 are attained.

Further, in Embodiments 1 and 2, the magnetic material sealing member 10r is mounted into the developing means frames, i.e., the first and second developing means frames but may be mounted into one developing means frame as in the conventional developing apparatus. Also in this case, effects similar to those described above are achieved.

In Embodiment 2, the magnetic material sealing member 10r has the structure shown in FIGS. 21 and 22 described above, so that the following effects are attained.

A positional accuracy for adhesion of the elastic member is improved by using the projection surface of the projection portion 10r10 located substantially perpendicular to the elastic member abutting surface is utilized as the striking surface at the time of adhesion of the elastic member.

By imparting a magnetic force to the outer peripheral surface 10r4, the toner leakage from the gaps (and spacing) between the magnetic material sealing member 10r an the developing means frame is prevented with reliability. Further, an area of the inner peripheral surface is increased by providing the projection portion 10r10, a toner leakage preventing ability from the end portions of the developing roller 10d is further improved.

Further, it is possible to prevent noises caused by leak by making the elastic member 30 non-electroconductive without employing additional parts as countermeasure against leak. Accordingly, the developing apparatus of the present invention is advantageous in terms of production costs and assembly performance.

[Other Embodiments]

The process cartridge used in the above described embodiments is used for forming a monochrome image but the process cartridge used in the developing apparatus of the present invention may also be suitably applicable to a process cartridge for forming a plurality of color images (e.g., two color images, three color images, full-color images) in combination with a plurality of developing means.

As for the electrophotographic photoconductive substance compatible with the above described embodiments, such a photoconductive substance as amorphous silicon, amorphous selenium, zinc oxide, titanium oxide, and various organic photoconductors (OPC), can be included. Incidentally, the photosensitive member in the above described embodiments may comprise a drum (cylinder) or belt formed of aluminum alloy or the like, and a layer of photoconductive substance placed on the peripheral surface of the cylinder or belt by deposition, painting, or the like.

The above described embodiments of the present invention are compatible with various well-known developing methods, for example, the two-component magnetic brush developing method, cascade developing method, touch-down developing method, cloud developing method, etc.

In the above described embodiments, a so-called contact charging method is employed as a charging method but may be changed to other conventional methods such as a charging method wherein a metal shield is provided to three peripheral portions of a tungsten wire and positive or negative ions generated by applying a high voltage to the tungsten wire are moved to the surface of the photosensitive drum to uniformly electrically charge the photosensitive drum surface.

In addition to the roller-type charging means described above, it is also possible to use various charging means of a blade-type (charging blade), a pad-type, a block-type, a rod-type, and a wire-type.

As a means for removing the toner remaining on the photosensitive drum, cleaning means of blade-type a fur-brush type, and a magnetic-brush type may be applicable.

The process cartridge used in the present invention comprises, e.g., the electrophotographic photosensitive member and at least one of a plurality of process means.

The present invention is compatible with: a cartridge in which an electrophotographic photoconductive member, and a developing means are integrally disposed, and which is removably mountable in the main assembly of an image forming apparatus; a cartridge in which an electrophotographic photoconductive member, a developing means, and a charging means or a cleaning means are integrally disposed, and which is removably mountable, in the main assembly of an image forming apparatus; and the like, in addition to the process cartridge B in the above described embodiments of the present invention. In other words, the process cartridge used in the present invention includes at least a developing means and an electrophotographic photosensitive member which are integrally disposed to form a cartridge which is detachably mountable to the main assembly of an image forming apparatus. This process cartridge can be mounted into and demounted from the apparatus main body by a user himself/herself. Accordingly, maintenance of the apparatus main body can be effected by a user alone.

Further, the electrophotographic image forming apparatus is the laser beam printer in the above embodiment but is also applicable to other electrophotographic image forming apparatuses such as an electrophotographic copying machine, an electrophotographic printer such as an LED printer, a facsimile apparatus, a word processor, a combination of two or ore of the preceding apparatuses such as a multiple function printer.

According to the present invention, the magnetic material sealing member is constituted as described hereinabove. As a result, the magnetic material sealing member can be simply assembled in a small space only by rotating it in contact with the developing means frame and can effect sealing with reliability.

Furthermore, the present invention is not limited to the above described embodiments, and variations and modifications may be made within the scope of the present invention.

1. A developing apparatus, comprising:
a developing container for containing a developer;
a developer carrying member to be rotated while carrying the developer thereon, said developer carrying member being provided in an opening portion of said developer container; and
a sealing member which extends in a circumferential direction of said developer carrying member in the vicinity of an end of said developer carrying member and regulates movement of the developer toward the end of said developer carrying member by a magnetic force, said sealing member including an arcuate portion extended along a peripheral surface of said developer carrying member and a non-arcuate portion disposed at an end, in the circumferential direction, of the arcuate portion;
wherein an end surface of the arcuate portion of said sealing member on a side where the non-arcuate portion is not provided, is inclined such that a phantom plane including the end surface is closer to the arcuate portion than a center of arcuation of the arcuate portion.

2. An apparatus according to claim 1, wherein said apparatus further comprises urging means for pressing the non-arcuate portion.

3. An apparatus according to claim 2, wherein said pressing means includes a layer thickness regulation member or regulating a thickness of a layer of the developer to be carried by said developer carrying member and an elastic member to be disposed between the non-arcuate portion and said layer thickness regulation member.

4. An apparatus according to claim 3, wherein said elastic member is electrically insulative.

5. An apparatus according to claim 3, a projection is disposed between said arcuate portion and said non-arcuate portion.

6. An apparatus according to claim 1, wherein said sealing member includes a magnet and a magnetic material.

7. A sealing member for sealing magnetic particles, comprising:
an arcuate portion extended opposite to a peripheral surface of a rotation member for carrying magnetic particles,
a non-arcuate portion disposed at an, in the circumferential direction, end of the arcuate portion;
wherein an end surface of the arcuate portion of said sealing member on a side where the non-arcuate portion is not provided, is inclined such that a phantom plane including the end surface is closer to the arcuate portion than a center of arcuation of the arcuate portion.

8. An apparatus according to claim 7, a projection is disposed between said arcuate portion and said non-arcuate portion.

9. An apparatus according to claim 7, wherein said sealing member includes a magnet and a magnetic material.
